(19) United States
(12) Patent Application Publication
(10) Pub. No.: US 2007/0242150 A1
(43) Pub. Date: Oct. 18, 2007

(54) DISPLAY APPARATUS AND IMAGING DEVICE

(76) Inventor: Hiroshi TERADA, Tokyo (JP)

Correspondence Address: OSTROLENK FABER GERB & SOFFEN, 1180 AVENUE OF THE AMERICAS, NEW YORK, NY, 100368403, US

(21) Appl. No.: 11/733,916

(22) Filed: Apr. 11, 2007

(30) Foreign Application Priority Data
Apr. 13, 2006 (JP) 2006-110978
Apr. 13, 2006 (JP) 2006-110979

(51) Int. Cl. H04N 5/222

(52) U.S. Cl. 348/333.06

(57) ABSTRACT

Disclosed are a display apparatus having a display section tiltable in at least two directions within a predetermined tilting range using at least four tilting members, and an imaging device using the display apparatus. An example of the predetermined range, a range where a display surface of the display section intersects the optical axis of a photographing lens can be adopted. The display apparatus can be configured in such a way that while a tilting member is tilted, tilting of other tilting member is inhibited.

### CROSS REFERENCES TO RELATED APPLICATION

This application is based upon and claims the benefit of priority from prior Japanese Patent Application Nos. 2006-110978, filed on Apr. 13, 2006, and 2006-110979, filed on Apr. 13, 2006, the entire contents of which are incorporated herein by reference.

### BACKGROUND OF THE INVENTION

1. Field of the Invention

The present invention relates to a display apparatus and an imaging device using the display apparatus.

2. Description of the Related Art

Some imaging devices, such as a camera, have a display section like a liquid crystal display, which displays an image formed by a photographing lens, disposed at the back portion of the imaging device body. Some of the imaging devices of this type are configured in such a way that the display section is movable with respect to the imaging device body to ensure imaging at various angles.

In an imaging device disclosed in Japanese Patent Laid-Open No. 2003-315891, for example, a display section is disposed at the base position along the back surface of a device body. A user can move the display section by turning the display section by an approximately 180° from the base position about a first pivot provided between one side of the device body and one side of the display section. Further, the user can move the display section by turning the display section about a second pivot provided orthogonal to a nearly center portion of the first pivot. That is, imaging is possible at various angles by combining the movement of the display section about the first pivot and the movement of the display section about the second pivot.

### BRIEF SUMMARY OF THE INVENTION

A display apparatus of the present invention realizes a display section tiltable in at least two directions within a predetermined tilting range using at least four tilting members.

An example of the predetermined range can be a range where the display surface of the display section intersects the optical axis of a photographing lens. The display apparatus can be configured in such a way that while some of the tilting members are moving, moving of the other tilting members is inhibited.

As one structural example, the display apparatus includes a first tilting member provided so as to be tiltable in a first direction with respect to a predetermined base portion; a second tilting member provided so as to be tiltable in the same direction as the first direction with respect to the first tilting member; a third tilting member provided so as to be tiltable in a second direction different from the first direction with respect to the second tilting member; a fourth tilting member provided so as to be tiltable in the same direction as the second direction with respect to the third tilting member; and a display section provided on the fourth tilting member.

The present invention can be understood as an invention of an imaging device using the above described display apparatus.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a perspective view showing an imaging device using a display apparatus from the back surface;

FIG. 2 is an exploded perspective view showing the display apparatus from below;

FIG. 3 is a perspective view illustrating the operation of the display apparatus;

FIG. 4 is a perspective view illustrating the operation of the display apparatus;

FIG. 5 is a perspective view illustrating the operation of the display apparatus; and

FIG. 6 is a perspective view illustrating the operation of the display apparatus.

### DETAILED DESCRIPTION OF THE PREFERRED EMBODIMENT

A preferred embodiment of the invention is described below with reference to the accompanying drawings.

It is to be noted that the present invention is not limited to the embodiment.

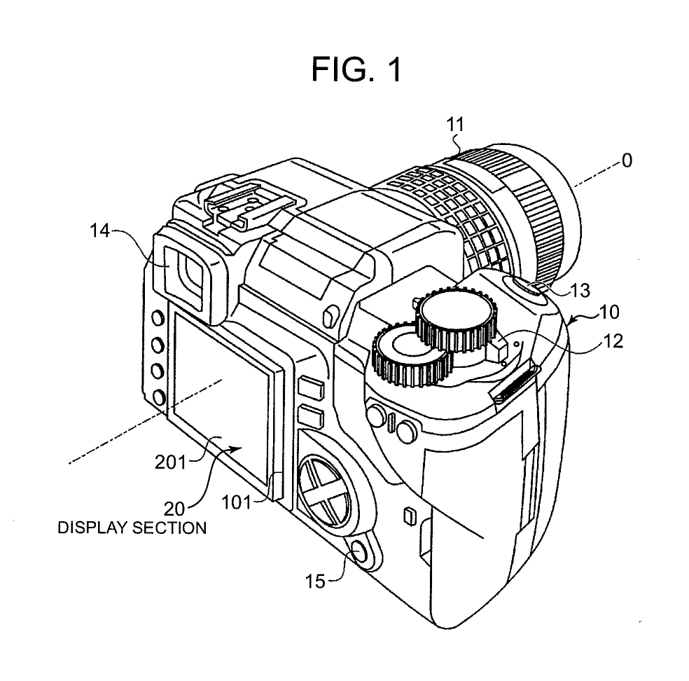

FIG. 1 is a perspective view showing an imaging device using a display apparatus from the back surface. The imaging device that will be described herein by way of example is a camera which takes pictures. Particularly, the imaging device is exemplified as a digital camera which captures a subject image with an image pickup device (CCD or the like), and stores the captured image as digital information in a memory medium.

As shown in FIG. 1, the imaging device (imaging section) has an imaging device body 10 which forms an approximately rectangular casing, and a photographing lens 11 provided at the front surface portion of the imaging device body 10. The photographing lens 11 forms a subject image on an image pickup device (not shown) disposed inside the imaging device body 10, and is provided with its optical axis O extending in the front surface and back surface direction.

Provided at the top side portion of the imaging device body 10 are a power switch 12 which sets the imaging device in an operational state or a non-operational state, and a shutter release button 13 which, when operated, inputs an imaging instruction. Provided at the back surface portion of the imaging device body 10 are a view finder 14 to view the subject image formed by the photographing lens 11, and a display section 20 including a liquid crystal display constituting a display apparatus. Provided at the back surface portion of the imaging device body 10 is a display button 15 for displaying the subject image, captured by the photographing lens 11, on the display section 20 when the imaging device is in the operational state. Operational buttons for making various settings of the imaging device are provided at the back surface portion of the imaging device body 10.

A user operates the power switch 12 of the imaging device to sets the display apparatus operational, and sees a subject image, formed by the photographing lens 11, through the view finder 14 or on the display section 20. Then, the user presses the shutter release button 13 to capture the subject image formed by the photographing lens 11 by means of the image pickup device (not shown), and stores the image in the memory medium (not shown). When the user performs an operation to reproduce an image in the operational state, the imaging device displays the image stored in the memory medium on the display section 20.

The display apparatus has the display section 20, provided at the back surface portion of the imaging device body (base portion) 10, for displaying a subject image captured by the photographing lens 11 or an image stored in the memory medium as mentioned above. The display section 20 has an approximately parallelepiped outer shape, and is retained in a retaining recess 101. The retaining recess 101 has an opening approximately rectangular shape formed in the back surface portion of the imaging device body 10, as shown in FIG. 1. The display section 20 has a rectangular display surface 201 on the surface that faces the direction of the back surface at a base position at which the display section 20 is retained in the retaining recess 101. The display section 20 of the display apparatus is configured so as to be movable from the base position with respect to the imaging device body 10.

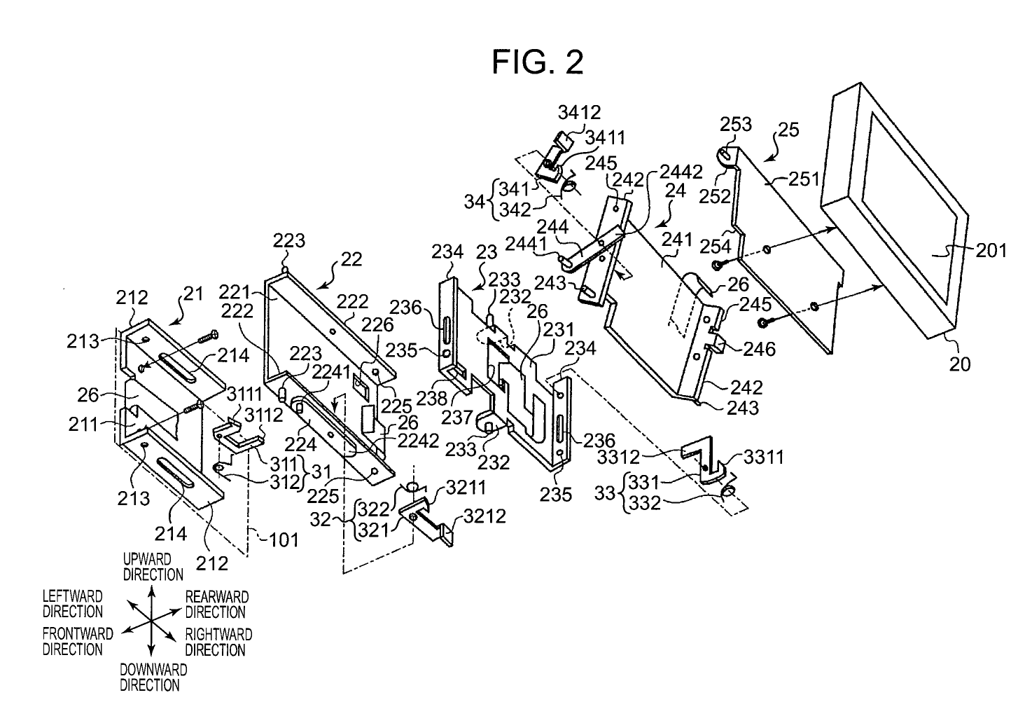

FIG. 2 is an exploded perspective view showing the display apparatus from below. As shown in FIG. 2, the display apparatus has a fixing member 21, a first tilting member 22, a second tilting member 23, a third tilting member 24 and a fourth tilting member 25 in addition to the display section 20. The fixing member 21 is fixed to the imaging device body 10 and is coupled to the display section 20 via the first tilting member 22, the second tilting member 23, the third tilting member 24 and the fourth tilting member 25. The display section 20 is fixed to the fourth tilting member 25. The fixing member 21 and the first tilting member 22 are jointed together in such a way as to be tiltable relative to each other. So are the first tilting member 22 and the second tilting member 23, the second tilting member 23 and the third tilting member 24, and the third tilting member 24 and the fourth tilting member 25.

The fixing member 21 is fixed to the bottom of the retaining recess 101 of the imaging device body 10 by screws at the plate surface of a flat-shaped plate 211. The fixing member 21 also has a pair of support pieces 212 provided by folding the upper and lower end portions of the plate 211 upright in the outward direction of the retaining recess 101 (the back-surface direction of the imaging device body 10). A pivot hole 213 and an elongated hole 214 are provided in each support piece 212. The pivot hole 213 is provided on one side of the support piece 212 at a portion closer to the left side of the imaging device body 10. The elongated hole 214 is provided in the center of the support piece 212 in a direction extending from one side toward the other side (the left and right direction of the imaging device body 10).

The first tilting member 22 has a pair of support pieces 222 provided by folding the upper and lower end portions of a flat-shaped plate 221 upright in the back-surface direction of the imaging device body 10. A pivot (first pivot) 223, a joint arm 224 and a pivot hole 225 are provided in each support piece 222. The pivot 223 is provided, extending vertically, on one side of the support piece 222 at a portion closer to the left side of the imaging device body 10. The joint arm 224 has a lengthwise middle portion pivoted in the center of the support piece 222 in a rotatable manner. The pivot hole 225 is provided on the other side of the support piece 222 at a portion closer to the right side of the imaging device body 10.

The first tilting member 22 is fixed to the fixing member 21 with the plate surface of its own plate 221 placed against the plate surface of the plate 211 of the fixing member 21 at the base position where the first tilting member 22 is retained between the support pieces 212. The pivot 223 is pivoted in the pivot hole 213 of the fixing member 21. The joint arm 224 has a pin 2241 provided at one end thereof to be inserted into the elongated hole 214 of the fixing member 21. Therefore, the first tilting member 22 can tilt in the left and right direction (first direction) from the base position about the pivot hole 213 and the pivot 223 provided at portions closer to the left side of the imaging device body 10. Further, at the time of tilting the first tilting member 22, the tilt angle of the first tilting member 22 is defined by the engagement of the pin 2241 of the joint arm 224 with the elongated hole 214 of the fixing member 21. As mentioned above, the first tilting member 22 is tiltable with respect to the fixing member 21 (and the imaging device body (base portion) 10 to which the fixing member 21 is fixed).

The second tilting member 23 has a pair of support pieces 232 provided by folding the upper and lower end portions of a flat-shaped plate 231 upright in the front-surface direction of the imaging device body 10. A pivot (second pivot) 233 is provided in each support piece 232. The second tilting member 23 also has a pair of support pieces 234 provided by folding the left and right end portions of the plate 231 upright in the back-surface direction of the imaging device body 10. A pivot hole 235 and an elongated hole 236 are provided in each support piece 234. The pivot hole 235 is provided on one side of the support piece 234 at a portion closer to the bottom side of the imaging device body 10. The elongated hole 236 is provided in the center of the support piece 234 in a direction extending from one side toward the other side (the up and down direction of the imaging device body 10).

The second tilting member 23 is fixed to the first tilting member 22 with the plate surface of its own plate 231 placed against the plate surface of the plate 221 of the first tilting member 22 at the base position where the second tilting member 23 is retained between the support pieces 222 of the first tilting member 22. The pivot 233 extending vertically is pivoted in the pivot hole 225 of the first tilting member 22, and is disposed in parallel to the pivot 223 of the first tilting member 22. The second tilting member 23 can tilt in the left and right direction (the same direction as the first direction) from the base position about the pivot hole 225 and the pivot 233 provided at portions closer to the right side of the imaging device body 10. As mentioned above, the second tilting member 23 is tiltable about the pivot 233, provided between the first tilting member 22 and the second tilting member 23, with respect to the first tilting member 22.

The third tilting member 24 has a pair of support pieces 242 provided by folding the left and right end portions of a flat-shaped plate 241 upright in the back-surface direction of the imaging device body 10. A pivot (third pivot) 243, a joint arm 244 and a pivot hole 245 are provided in each support piece 242. The pivot 243 is provided on one side of the support piece 242 at a portion closer to the bottom side of the imaging device body 10. The joint arm 244 has a lengthwise middle portion pivoted in the center of the support piece 242 in a rotatable manner. The pivot hole 245 is provided on the other side of the support piece 242 at a portion closer to the top side of the imaging device body 10.

The third tilting member 24 is fixed to the second tilting member 23 with the plate surface of its own plate 241 placed against the plate surface of the plate 231 of the second tilting member 23 at the base position where the third tilting member 24 is retained between the support pieces 234 of the second tilting member 23. The pivot 243 is pivoted in the pivot hole 235 of the second tilting member 23. Accordingly, the pivot 243 is disposed extending in the left and right direction in a twisting relationship (not in parallel) with the directions of the pivot 223 of the first tilting member 22 and the pivot 233 of the second tilting member 23. The joint arm 244 has a pin 2441 provided at one end thereof extending in the left and right direction to be inserted into the elongated hole 236 of the second tilting member 23. The third tilting member 24 can tilt in the up and down direction (second direction) from the base position about the pivot hole 235 and the pivot 243 provided at portions closer to the bottom side of the imaging device body 10. Further, at the time of tilting the third tilting member 24, the tilt angle of the third tilting member 24 is defined by the engagement of the pin 2241 of the joint arm 244 with the elongated hole 236 of the second tilting member 23. As mentioned above, the third tilting member 24 is tiltable with respect to the second tilting member 23 about the pivot 243 provided between the second tilting member 23 and the third tilting member 24.

The fourth tilting member 25 has a pair of support pieces 252 provided by folding the left and right end portions of a flat-shaped plate 251 upright in the back-surface direction of the imaging device body 10. A pivot (fourth pivot) 253 is provided in each support piece 252, and is extending in the left and right direction. The pivot 253 is provided on one side of the support piece 252 at a portion closer to the top side of the imaging device body 10.

The fourth tilting member 25 is fixed to the third tilting member 24 with the plate surface of its own plate 251 placed against the plate surface of the plate 241 of the third tilting member 24 at the base position where the fourth tilting member 25 is retained between the support pieces 242 of the third tilting member 24. The pivot 253 is pivoted in the pivot hole 245 of the third tilting member 24, and is disposed in parallel to the pivot 243 of the third tilting member 24. The fourth tilting member 25 can tilt in the up and down direction (fourth direction) from the base position about the pivot hole 245 and the pivot 253 provided at portions closer to the top side of the imaging device body 10. As mentioned above, the fourth tilting member 25 is tiltable about the pivot 253, provided between the third tilting member 24 and the fourth tilting member 25, with respect to the third tilting member 24. Further, the display section 20 is fixed to the plate surface of the plate 251 of the fourth tilting member 25 by screws.

In the display apparatus, a flexible printed board 26 led from the imaging device body 10 is connected to the display section 20. The flexible printed board 26 is led to the display section 20 from the imaging device body 10 along the first tilting member 22, the second tilting member 23 and the third tilting member 24.

Specifically, as shown in FIG. 2, the flexible printed board 26 extends from the left end of the plate 211 of the fixing member 21 to the right end of the first tilting member 22, passing between the plate 211 and the plate 221 of the first tilting member 22. The flexible printed board 26 is then folded back at the right end of the plate 221 of the first tilting member 22, extends leftward, passes between the plate 221 and the plate 231 of the second tilting member 23, and passes through a through hole 237, formed in approximately the center of the plate 231, in the back-surface direction of the imaging device body 10. The flexible printed board 26 is then folded back at the through hole 237, extends rightward, passes between the plate 231 and the plate 241 of the third tilting member 24, reaches the lower end portion of the third tilting member 24 in a pattern of an approximately Z shape, is folded back at the lower end portion, and extends upward and reaches the upper end of the third tilting member 24. The flexible printed board 26 then extends from the upper end of the third tilting member 24 and reaches the display section 20.

That is, the flexible printed board 26 is adapted to flexibly cope with bending and twisting, and is folded back at the pivots 223, 233, 243, 253, passing between the fixing member 21 and the first tilting member 22, between the first tilting member 22 and the second tilting member 23, and between the second tilting member 23 and the third tilting member 24. As a result, the flexible printed board 26 extends from the imaging device body 10 to the display section 20 to be connected thereto without interfering with tilting of each tilting member 22, 23, 24, 25.

The display apparatus has a restriction mechanism that, when the first tilting member 22 and the second tilting member 23 tilt, restricts the tilting of the third tilting member 24 and the fourth tilting member 25. When the third tilting member 24 and the fourth tilting member 25 tilt, the restriction mechanism restricts the tilting of the first tilting member 22 and the second tilting member 23. The first tilting member 22 and the second tilting member 23 tilt in the same direction, and consist a first tiling mechanism. The third tilting member 24 and the fourth tilting member 25 tilts in the same direction that is different from the tiling direction of the first tilting mechanism, and consist a second tilting mechanism.

As shown in FIG. 2, the restriction mechanism has a first restriction section 31, a second restriction section 32, a third restriction section 33 and a fourth restriction section 34.

The first restriction section 31 has a hook member 311 and a spring 312. The hook member 311 has an approximately “U” shape, and has, at one end, a hook portion 3111 extending outward, and, at the other end, a pressed portion 3112 contiguous to the hook portion 3111 and extending straight. The hook member 311 is pivoted in the retaining recess 101 of the imaging device body 10 in a rotatable manner (tiltable manner) by a pivot (not shown) extending in the up and down direction. The hook member 311 is biased by the spring 312 in such a way that the hook portion 3111 is moved frontward. The hook portion 3111 of the hook member 311 can be inserted into an engagement hole 226 provided in the plate 221 of the first tilting member 22.

The hook portion 3111 of the hook member 311 engages with the engagement hole 226 of the first tilting member 22 positioned at the base position by the biasing force of the spring 312, thereby restricting the tilting of the first tilting member 22 (restricted state). When the pressed portion 3112 is pressed against the biasing force of the spring 312, the hook portion 3111 of the hook member 311 is disengaged from the engagement hole 226 of the first tilting member 22, thereby permitting the tilting of the first tilting member 22 (released state). The pressed portion 3112 of the hook member 311 is pressed frontward by the display section 20 at the base position or the plate 241 of the third tilting member 24. That is, the first restriction section 31 permits the tilting of the first tilting member 22 when the display section 20 is at the base position, and the restricts the tilting of the first tilting member 22 when the display section 20 is moved from the base position by the tilting of the third tilting member 24.

The second restriction section 32 has a hook member 321 and a spring 322. The hook member 321 has an approximately “U” shape, and has, at one end, a hook portion 3211 extending inward of the “U” shape, and, at the other end, a pressed portion 3212 extending outside. The hook member 321 is pivoted in the center portion of the support piece 222 of the first tilting member 22 in a rotatable manner (tiltable manner) by a pivot (not shown) extending in the up and down direction. The hook member 321 is biased by the spring 322 in such a way that the hook portion 3211 is moved rearward. The hook portion 3211 of the hook member 321 can be inserted into an engagement hole 238 provided in the plate 231 of the second tilting member 23.

The hook portion 3211 of the hook member 321 engages with the engagement hole 238 of the second tilting member 23 positioned at the base position by the biasing force of the spring 322, thereby restricting the tilting of the second tilting member 23 (restricted state). When the pressed portion 3212 is pressed against the biasing force of the spring 322, the hook portion 3211 of the hook member 321 is disengaged from the engagement hole 238 of the second tilting member 23, thereby permitting the tilting of the second tilting member 23 (released state). The pressed portion 3212 of the hook member 321 is pressed rearward by one end 2242 of the joint arm 224 which is operated when the first tilting member 22 is tilted. That is, the second restriction section 32 permits the tilting of the second tilting member 23 when the first tilting member 22 is tilted with respect to the fixing member 21 (the imaging device body (base portion) 10), and the restricts the tilting of the second tilting member 23 when the first tilting member 22 is not tilted with respect to the fixing member 21 (the imaging device body (base portion) 10).

The third restriction section 33 has a hook member 331 and a spring 332. The hook member 331 has an approximately “Z” shape, and has, at one end, a hook portion 3311 extending outward, and, at the other end, a pressed portion 3312 contiguous to the hook portion 3311 and extending straight. The hook member 331 is pivoted in the support piece 234 of the second tilting member 23 in a rotatable manner (tiltable manner) by a pivot (not shown) extending in the left and right direction. The hook member 331 is biased by the spring 332 in such a way that the hook portion 3311 is moved rearward. The hook portion 3311 of the hook member 331 can engage with an engagement piece 246 provided in the support piece 242 of the third tilting member 24.

The hook portion 3311 of the hook member 331 engages with the engagement piece 246 of the third tilting member 24 by the biasing force of the spring 332 in the tilt state where the second tilting member 23 is not at the base position, i.e., in the tilt state where the first tilting member 22 is not at the base position, thereby restricting the tilting of the third tilting member 24 (restricted state). When the pressed portion 3312 is pressed against the biasing force of the spring 332, i.e., when the second tilting member 23 and the third tilting member 24 are at the base position, the hook portion 3311 of the hook member 331 is disengaged from the engagement piece 246 of the third tilting member 24, thereby permitting the tilting of the third tilting member 24 (released state). The pressed portion 3312 of the hook member 331 is pressed rearward by the imaging device body 10 when the display section 20 is at the base position. That is, the third restriction section 33 permits the tilting of the third tilting member 24 when the display section 20 is at the base position, and the restricts the tilting of the third tilting member 24 when the display section 20 is moved from the base position by the tilting of the first tilting member 22.

The fourth restriction section 34 has a hook member 341 and a spring 342. The hook member 341 has an approximately “U” shape, and has, at one end, a hook portion 3411 extending inward of the “U” shape, and, at the other end, a pressed portion 3412 extending outside. The hook member 341 is pivoted in the center portion of the support piece 242 of the third tilting member 24 in a rotatable manner (tiltable manner) by a pivot (not shown) extending in the left and right direction. The hook member 341 is biased by the spring 342 in such a way that the hook portion 3411 is moved rearward. The hook portion 3411 of the hook member 341 can be inserted into a cutaway portion 254 provided in the plate 251 of the fourth tilting member 25.

When the third tilting member 24 is not tilted with respect to the second tilting member 23, the hook portion 3411 of the hook member 341 engages with the cutaway portion 254 of the fourth tilting member 25 by the biasing force of the spring 342, thereby restricting the tilting of the fourth tilting member 25 (restricted state). When the pressed portion 3412 is pressed against the biasing force of the spring 342, the hook portion 3411 of the hook member 341 is disengaged from the cutaway portion 254 of the fourth tilting member 25, thereby permitting the tilting of the fourth tilting member 25 (released state). The pressed portion 3412 of the hook member 341 is pressed rearward by one end 2442 of the joint arm 244 which is operated when the third tilting member 24 is tilted. That is, the fourth restriction section 34 permits the tilting of the fourth tilting member 25 when the third tilting member 24 is tilted with respect to the second tilting member 23, and the restricts the tilting of the fourth tilting member 25 when the third tilting member 24 is not tilted with respect to the second tilting member 23.

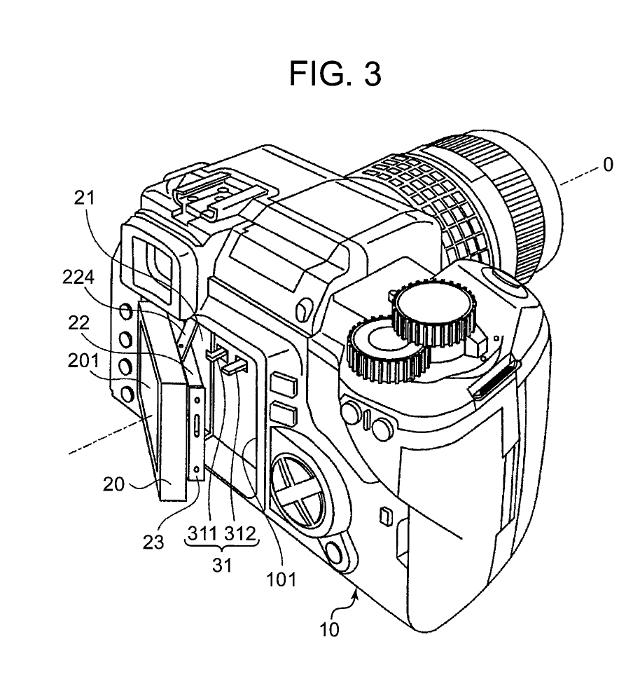

FIGS. 3 through 6 are perspective views illustrating the operation of the display apparatus at the position (second position) to which the display section 20 is moved from the base position. With the display section 20 being at the base position (first position), as shown in FIG. 1, the first restriction section 31 is in the released state, the second restriction section 32 is in the restricted state, the third restriction section 33 is in the released state, and the fourth restriction section 34 is in the restricted state. That is, the first tilting member 22 and the third tilting member 24 are in a tiltable state at the base position shown in FIG. 1.

First, because the first restriction section 31 is in the released state at the base position shown in FIG. 1, the first tilting member 22 is in a tiltable state. Therefore, the user can move the display section 20 by tilting the first tilting member 22 as shown in FIG. 3. The display section 20 is attached to the first tilting member 22 via the second tilting member 23, the third tilting member 24 and the fourth tilting member 25. This allows the display section 20 to tilt about the pivot (first pivot) 223 in the left and right direction (first direction) with the left end side of the display section 20 corresponding to the rotational axis according to the tilting of the first tilting member 22. When the user tilts the first tilting member 22 this way, the display section 20 is tilted in the left and right direction with the left end side of the display section 20 being the rotational axis, so that the display section 20 is tilted within the range where the display section 20 intersects the optical axis O of the photographing lens 11. In this state, the user can capture a subject image displayed on the display surface 201 of the display section 20 at an angle of viewing the subject image from the left side with the imaging device being set at a horizontal position (horizontal long frame). Further, the user can capture a subject image displayed on the display surface 201 of the display section 20 at an angle of viewing the subject image from above or under with the imaging device being set at a vertical position (vertically long frame).

When the user tilts the first tilting member 22, the joint arm 224 of the first tilting member 22 presses the pressed portion 3212 of the second restriction section 32 according to the tilting of the first tilting member 22, setting the second restriction section 32 in the released state where the second tilting member 23 is tiltable. As the pressed portion 3312 of the third restriction section 33 is moved away from the imaging device body 10 according to the tilting of the first tilting member 22, the third restriction section 33 comes to the restricted state, thus restricting the tilting of the third tilting member 24. The fourth restriction section 34 stays restricted. That is, the second tilting member 23 which is a part of the first restriction mechanism is in a tiltable state according to the tilting of the first tilting member 22 which is a part of the first restriction mechanism. Meanwhile, the third tilting member 24 and the fourth tilting member 25 which are the second restriction mechanism come to the restricted state.

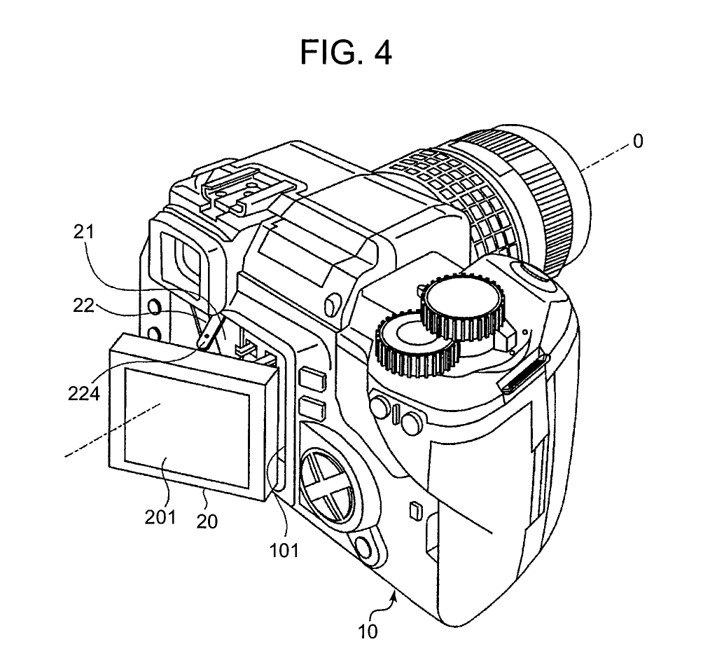

Next, the user tilts the second tilting member 23 as shown in FIG. 4. The display section 20 is attached to the second tilting member 23 via the third tilting member 24 and the fourth tilting member 25. This allows the display section 20 to tilt about the pivot (second pivot) 233 in the left and right direction with the center of the display section 20 being the rotational axis according to the tilting of the second tilting member 23. When the user tilts the second tilting member 23 this way, the display section 20 is tilted in the same direction as the first tilting member 22 with nearly the center of the display section 20 being the rotational axis, so that the display section 20 is tilted within the range where the display section 20 intersects the optical axis O of the photographing lens 11. In this state, the user can capture a subject image displayed on the display surface 201 of the display section 20 at an angle of viewing the subject image from the right side with the imaging device being set at a horizontal position (horizontal long frame). Further, the user can capture a subject image displayed on the display surface 201 of the display section 20 at an angle of viewing the subject image from above or under with the imaging device being set at a vertical position (vertically long frame).

When the user tilts the second tilting member 23, the pressed portion 3312 of the third restriction section 33 is moved away from the imaging device body 10 according to the tilting of the first tilting member 22, the third restriction section 33 comes to the restricted state of restricting the tilting of the third tilting member 24. The fourth restriction section 34 stays restricted. That is, the tilting of the third tilting member 24 and the fourth tilting member 25 which are the second restriction mechanism is kept restricted unless the first tilting member 22 and the second tilting member 23 which are the first restriction mechanism are returned to the base position to set the display section 20 at the base position.

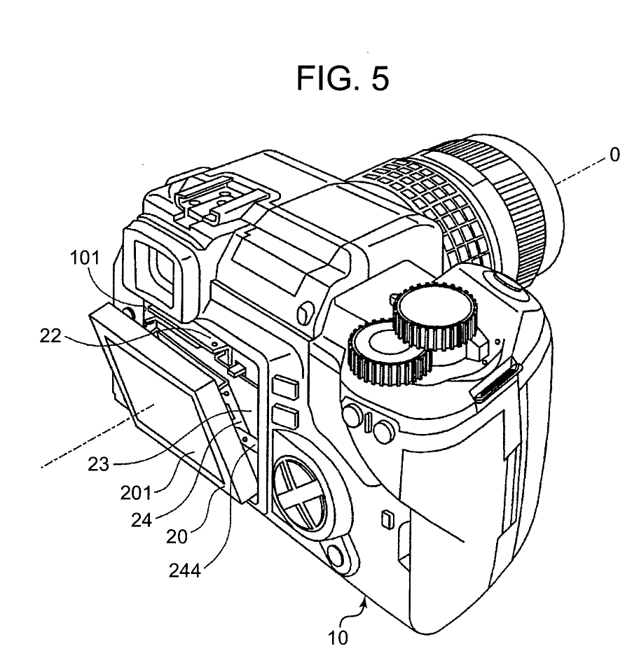

Next, a description will be given of a case where the user moves the display section 20 by tilting the third tilting member 24 from the base position in FIG. 1 as shown in FIG. 5. As mentioned above, because the third restriction section 33 is in the released state with the display section 20 being at the base position, the third tilting member 24 is in a tiltable state. Therefore, the user can tilt the third tilting member 24. The display section 20 is attached to the third tilting member 24 via the fourth tilting member 25. This allows the display section 20 to tilt about the pivot (third pivot) 243 in the up and down direction (second direction different from the first direction and in a twisted relationship therewith) with the lower end side of the display section 20 corresponding to the rotational axis according to the tilting of the third tilting member 24. When the user tilts the third tilting member 24 this way, the display section 20 is tilted in the up and down direction with the lower end side of the display section 20 being the rotational axis, so that the display section 20 is tilted within the range where the display section 20 intersects the optical axis O of the photographing lens 11. In this state, the user can capture a subject image displayed on the display surface 201 of the display section 20 at an angle of viewing the subject image from under with the imaging device being set at a horizontal position (horizontal long frame). Further, the user can capture a subject image displayed on the display surface 201 of the display section 20 at an angle of viewing the subject image from the left side or right side with the imaging device being set at a vertical position (vertically long frame).

When the user tilts the third tilting member 24, the joint arm 244 of the third tilting member 24 presses the pressed portion 3412 of the fourth restriction section 34 according to the tilting of the third tilting member 24, setting the fourth tilting member 25 in the released state where the fourth tilting member 25 is tiltable. As the display section 20 and the third tilting member 24 are moved away from the pressed portion 3112 according to the tilting of the third tilting member 24, the first restriction section 31 comes to the restricted state of restricting the tilting of the first tilting member 22. The second restriction section 32 stays restricted. That is, according to the tilting of the third tilting member 24 which is a part of the second restriction mechanism, the fourth tilting member 25 which is a part of the second restriction mechanism comes to a tiltable state and the tilting of the first tilting member 22 and the second tilting member 23 which are the first restriction mechanism comes to the restricted state.

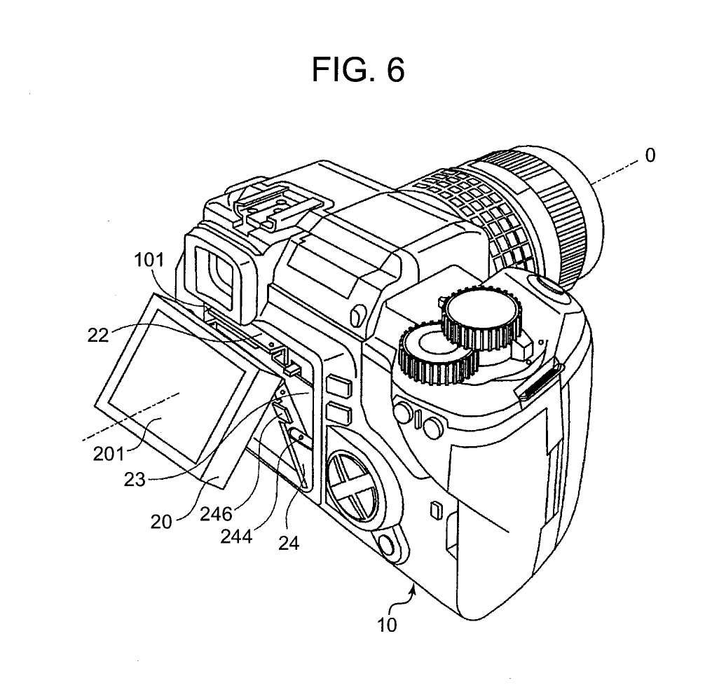

Accordingly, the user tilts the fourth tilting member 25 as shown in FIG. 6. The display section 20 is attached to the fourth tilting member 25. This allows the display section 20 to tilt about the pivot (fourth pivot) 253 in the up and down direction with the upper end side of the display section 20 corresponding to the rotational axis according to the tilting of the fourth tilting member 25. When the user tilts the fourth tilting member 25 this way, the display section 20 is tilted in the same direction as the third tilting member 24 with the upper end side of the display section 20 being the rotational axis, so that the display section 20 is tilted within the range where the display section 20 intersects the optical axis O of the photographing lens 11. In this state, the user can capture a subject image displayed on the display surface 201 of the display section 20 at an angle of viewing the subject image from above with the imaging device being set at a horizontal position (horizontal long frame). Further, the user can capture a subject image displayed on the display surface 201 of the display section 20 at an angle of viewing the subject image from the left side or the right side with the imaging device being set at a vertical position (vertically long frame).

When the user tilts the fourth tilting member 25, the display section 20 and the third tilting member 24 are moved away from the pressed portion 3112 of the first restriction section 31 according to the tilting of the third tilting member 24, the first restriction section 31 stays in the restricted state of restricting the tilting of the first tilting member 22. The second restriction section 32 stays restricted. That is, the tilting of the first tilting member 22 and the second tilting member 23 which are the first restriction mechanism is kept restricted unless the third tilting member 24 and the fourth tilting member 25 which are the second restriction mechanism are returned to the base position to set the display section 20 at the base position.

Each tilting member 22, 23, 24, 25 is configured in such a way that a predetermined frictional resistance is given to the tilting of each tilting member 22, 23, 24, 25 about the pivot (first pivot) 223, the pivot (second pivot) 233, the pivot (third pivot) 243, the pivot (fourth pivot) 253, so that the tilting member 22, 23, 24, 25 can hold the tilt position steplessly.

As described above, the display apparatus has the first tilting member 22 so provided as to be tiltable in the left and right direction (first direction) with respect to the imaging device body (base portion) 10, the second tilting member 23 so provided as to be tiltable in the left and right direction (the same direction as the first direction) with respect to the first tilting member 22, the third tilting member 24 so provided as to be tiltable in the up and down direction (second direction different from the first direction) with respect to the second tilting member 23, the fourth tilting member 25 so provided as to be tiltable in the up and down direction (same direction as the second direction) with respect to the third tilting member 24, and the display section 20 provided at the fourth tilting member 25.

In other words, the display apparatus has the first tilting member 22 so provided as to be tiltable about the pivot (first pivot) 223 disposed between the imaging device body 10 and the first tilting member 22 with respect to the imaging device body (base portion) 10, the second tilting member 23 so provided as to be tiltable about the pivot (second pivot) 233 disposed in parallel to the pivot (first pivot) 223 between the first tilting member 22 and the second tilting member 23, the third tilting member 24 so provided as to be tiltable about the pivot (third pivot) 243 disposed in a twisted relationship with the pivot (first pivot) 223 and the pivot (second pivot) 233 between the second tilting member 23 and the third tilting member 24, the fourth tilting member 25 so provided as to be tiltable about the pivot (fourth pivot) 253 disposed in parallel to the pivot (third pivot) 243 between the third tilting member 24 and the fourth tilting member 25, and the display section 20 provided at the fourth tilting member 25.

That is, the first tilting member 22 tilts in the left and right direction with respect to the imaging device body 10, the second tilting member 23 tilts in the left and right direction with respect to the first tilting member 22, the third tilting member 24 tilts in the up and down direction with respect to the second tilting member 23, and the fourth tilting member 25 tilts in the up and down direction with respect to the third tilting member 24. As a result, the display section 20 can be quickly and easily moved only in the desired direction while maintaining the ability of moving the display section 20 in other directions than the desired direction.

The display apparatus has the display section 20 having the display surface 201 arranged outward with respect to the imaging device body (base portion) 10, the first tilting mechanism (first tilting member 22 and second tilting member 23) which tilts the display section 20 in the left and right direction (predetermined direction) in a mode of changing the direction of the display surface 201, the second tilting mechanism (third tilting member 24 and fourth tilting member 25) which tilts the display section 20 in the up and down direction which is in the twisted relationship with the left and right direction in a mode of changing the direction of the display surface 201 to another direction, and the restriction mechanism (first restriction section 31, second restriction section 32, third restriction section 33 and fourth restriction section 34) which restricts the action of the second tilting mechanism when the first tilting mechanism is operated and restricts the action of the first tilting mechanism when the second tilting mechanism is operated.

In other words, the display apparatus having the display section 20 arranged at the imaging device body (base portion) 10 in such a way that the display section 20 is movable from the predetermined base position includes the first tilting member 22 so provided as to be tiltable in the left and right direction (first direction) with respect to the imaging device body 10, the second tilting member 23 so provided as to be tiltable in the left and right direction (same direction as the first direction) with respect to the first tilting member 22, the third tilting member 24 so provided as to be tiltable in the up and down direction (second direction) different from the left and right direction (first direction) with respect to the second tilting member 23, the fourth tilting member 25 so provided as to be tiltable in the up and down direction (same direction as the second direction) with respect to the third tilting member 24, the first restriction section 31 which permits the tilting of the first tilting member 22 when the display section 20 is at the base position and restricts the tilting of the first tilting member 22 when the display section 20 is moved from the base position according to the tilting of the third tilting member 24, the second restriction section 32 which permits the tilting of the second tilting member 23 when the first tilting member 22 is tilted with respect to the imaging device body 10 and restricts the tilting of the second tilting member 23 when the first tilting member 22 is not tilted with respect to the imaging device body 10, the third restriction section 33 which permits the tilting of the third tilting member 24 when the display section 20 is at the base position and restricts the tilting of the third tilting member 24 when the display section 20 is moved from the base position according to the tilting of the first tilting member 22, the fourth restriction section 34 which permits the tilting of the fourth tilting member 25 when the third tilting member 24 is tilted with respect to the second tilting member 23 and restricts the tilting of the fourth tilting member 25 when the third tilting member 24 is not tilted with respect to the second tilting member 23.

That is, when the first tilting mechanism (first tilting member 22 and second tilting member 23) which tilts in the left and right direction is operated, the action of the second tilting mechanism (third tilting member 24 and fourth tilting member 25) which tilts in the up and down direction is restricted. When the second tilting mechanism (third tilting member 24 and fourth tilting member 25) which tilts in the up and down direction is operated, the action of the first tilting mechanism (first tilting member 22 and second tilting member 23) which tilts in the left and right direction is restricted. As a result, there are no tilting actions different from the desired direction, so that the display section 20 can be stably moved only in the desired direction and at various angles.

The provision of the flexible printed board 26 led from the imaging device body (base portion) 10 to the display section 20 along the first tilting member 22, the second tilting member 23 and the third tilting member 24 can allow the imaging device body 10 to be connected to the display section 20 without interfering with the tilting of each tilting member 22, 23, 24, 25.

The display section 20 of the display apparatus displays a subject image captured by the imaging device. With the display apparatus adapted to the imaging device in the above-described manner, it is possible to prevent the display surface 201 from facing in an unintended direction while maintaining the ability of quickly and easily moving the display section 20 according to various angles of the imaging device.

The imaging device which captures a subject image formed by the photographing lens 11 has the display section 20 disposed at the back surface of the imaging device body 10 and having the display surface 201 facing outward which displays a subject image in such a way as to intersect the optical axis O of the photographing lens 11, the first tilting mechanism (first tilting member 22 and second tilting member 23) which tilts the display section 20 in the left and right direction (predetermined direction) within the range where the display surface 201 intersects the optical axis O of the photographing lens 11, and the second tilting mechanism (third tilting member 24 and fourth tilting member 25) which tilts the display section 20 in the up and down direction (another direction) which is in the twisted relationship with the left and right direction within the range where the display surface 201 intersects the optical axis O of the photographing lens 11. That is, the moved display section 20 does not shift from the optical axis O of the photographing lens 11. As a result, in a case of imaging a subject while viewing the subject image displayed on the display section 20 moved from the base position in the macro photography, particularly, it is also possible to align the position of the image to be captured by the photographing lens 11.

Although the individual restriction sections from the first restriction section 31 to the fourth restriction section 34 are provided according to the embodiment of the present invention, the restriction sections may be omitted. In this case, the display surface 201 of the display section 20 can be directed in every direction in the back-surface directions of the imaging device body 10. In other words, the display section 20 can be moved in every one of the back-surface directions of the imaging device body 10, i.e., in the pitching direction (up and down direction), the yawing direction (left and right direction), and the combination of both directions. According to the embodiment of the present invention, the display section 20 moved does not extend out of the outer shape sideward or in the up and down direction. In whichever the direction of the display surface 201 is set or in whatever state the imaging device body 10 is placed, the display section 20 does not interfere with another device or an object located close to the imaging device body 10, thus making it possible to freely set the state of the display section 20.

Although the fixing member 21 is used to indirectly attach the first tilting member 22 to the imaging device body 10, the fixing member 21 may be integrated with the imaging device body 10 with the first tilting member 22 directly attached to the imaging device body 10.

Although the fourth tilting member 25 is used to indirectly attach the third tilting member 24 to the display section 20, the fourth tilting member 25 may be integrated with the display section 20 with the display section 20 directly attached to the third tilting member 24.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A display apparatus comprising:
a first tilting member provided so as to be tiltable in a first direction with respect to a predetermined base portion;
a second tilting member provided so as to be tiltable in the same direction as the first direction with respect to the first tilting member;
a third tilting member provided so as to be tiltable in a second direction different from the first direction with respect to the second tilting member;
a fourth tilting member provided so as to be tiltable in the same direction as the second direction with respect to the third tilting member; and
a display section provided on the fourth tilting member.

2. The display apparatus according to claim 1, further comprising:
a first pivot, provided between the base portion and the first tilting member, for tilting the first tilting member;
a second pivot provided between the first tilting member and the second tilting member in parallel to the first pivot;
a third pivot provided between the second tilting member and the third tilting member at a position twisted from the second pivot; and
a fourth pivot provided between the third tilting member and the fourth tilting member in parallel to the third tilting member.

3. The display apparatus according to claim 2, wherein the third pivot is disposed at right angles to the second pivot.

4. The display apparatus according to claim 1, further comprising:
a flexible printed board elongated from the base portion to the display section along the first tilting member, the second tilting member and the third tilting member.

5. The display apparatus according to claim 1, wherein the base portion is an imaging section to capture a subject image, and the display section displays the subject image captured by the imaging section.

6. The display apparatus according to claim 1, further comprising:
a first restriction section that permits tilting of the first tilting member when the display section is at a base position, and restricts tilting of the first tilting member when the display section is moved from the base position along with the tilting of the third tilting member;
a second restriction section that permits tilting of the second tilting member when the first tilting member is tilted with respect to the base portion, and restricts tilting of the second tilting member when the first tilting member is not tilted with respect to the base portion;
a third restriction section that permits tilting of the third tilting member when the display section is at a base position, and restricts tilting of the third tilting member when the display section is moved from the base position along with the tilting of the first tilting member; and
a fourth restriction section that permits tilting of the fourth tilting member when the third tilting member is tilted with respect to the second tilting member, and restricts tilting of the fourth tilting member when the third tilting member is not tilted with respect to the second tilting member.

7. The display apparatus according to claim 6, wherein the base position is an initial position before all of the first to fourth tilting members tilt.

8. A display apparatus comprising:
a first tilting member provided so as to be tiltable about a first pivot with respect to the predetermined base portion, which pivot being provided between a predetermined base portion and the first tilting member;
a second tilting member provided so as to be tiltable about a second pivot with respect to the first tilting member, which second pivot being disposed in parallel to the first pivot between the first tilting member and the second tilting member;
a third tilting member provided so as to be tiltable about a third pivot with respect to the second tilting member, which second pivot being disposed between the second tilting member and the third tilting member at a position twisted from the second pivot;
a fourth tilting member provided so as to be tiltable about a fourth pivot with respect to the third tilting member, which forth pivot being disposed in parallel to the third pivot between the third tilting member and the fourth tilting member; and
a display section provided on the fourth tilting member.

9. The display apparatus according to claim 8, wherein the third pivot is disposed at right angles to the second pivot.

10. The display apparatus according to claim 8, further comprising:
a flexible printed board led from the base portion to the display section along the first tilting member, the second tilting member and the third tilting member.

11. The display apparatus according to claim 8, wherein the base portion is an imaging section to capture a subject image, and the display section displays the subject image captured by the imaging section.

12. An imaging device that captures a subject image formed with a photographing lens, comprising:
a display section disposed at a back surface of an imaging device body in such a way that a display surface for displaying the subject image intersects the optical axis of the photographing lens and the display surface faces outward;
a first tilting mechanism that tilts the display section in a predetermined direction within a range where the display surface intersects the optical axis of the photographing lens; and
a second tilting mechanism that tilts the display section in a direction twisted from the predetermined direction within the range where the display surface intersects the optical axis of the photographing lens.

13. A display apparatus comprising:
a display section with a display surface facing outward with respect to a predetermined base portion;
a first tilting mechanism that tilts the display section in a predetermined direction in such a way as to change a direction of the display surface;
a second tilting mechanism that tilts the display section in a direction twisted from the predetermined direction in such a way as to change the direction of the display surface to another direction; and
a restriction mechanism that restricts an action of the second tilting mechanism when the first tilting mechanism is in effective, and restricts an action of the first tilting mechanism when the second tilting mechanism is in effective.

14. The display apparatus according to claim 13, wherein the base portion is an imaging section to capture a subject image, and the display section displays the subject image captured by the imaging section.

15. An imaging device that captures a subject image formed with a photographing lens, comprising:
a display section with a display surface facing outward with respect to a predetermined base portion;
a first tilting mechanism that tilts the display section in a predetermined direction in such a way as to change a direction of the display surface;
a second tilting mechanism that tilts the display section in a direction twisted from the predetermined direction in such a way as to change the direction of the display surface to another direction; and
a restriction mechanism that restricts an action of the second tilting mechanism when the first tilting mechanism is in effective, and restricts an action of the first tilting mechanism when the second tilting mechanism is in effective.
